(19) United States
(12) Patent Application Publication
(10) Pub. No.: US 2022/0300593 A1
(43) Pub. Date: Sep. 22, 2022

(54) SYSTEM AND METHOD OF BIOMETRIC IDENTIFICATION OF A SUBJECT

(71) Applicant: Silk ID Systems Inc., Santa Clara, CA (US)

(72) Inventor: Kenneth Brownlee, Palo Alto, CA (US)

(73) Assignee: Silk ID Systems Inc., Santa Clara, CA (US)

(21) Appl. No.: 17/689,937

(22) Filed: Mar. 8, 2022

Related U.S. Application Data
(60) Provisional application No. 63/161,606, filed on Mar. 16, 2021.

(51) Int. Cl. G06F 21/32; G06V 40/13; G06V 40/12; G06V 40/145; G06V 10/141; G06V 10/143; G06V 10/147

(52) U.S. Cl. CPC G06F 21/32; G06V 40/1318; G06V 40/1371; G06V 40/1376; G06V 40/1353; G06V 40/1359; G06V 40/145; G06V 10/141; G06V 10/143; G06V 10/147

(57) ABSTRACT

Systems and methods of biometric identification of a subject have steps of providing a light source and an imager, positioning a subject hand palm facing the light source and imager, illuminating the palm with the light source, capturing an image of the palm, and determining characteristics of capillary beds in the image. The present invention may include the step of identifying the subject based on the characteristics of the capillary beds. The step of determining characteristics of capillary beds in the image may include determining locations of the capillary beds. The present invention may include the step of processing the image to filter image features of the palm other than the capillary beds. Processing the image to filter image features of the palm other than the capillary beds may include removing surface ridge pattern features and spatially filtering to remove detail with a frequency of less than a selected threshold.

### CROSS-REFERENCE TO RELATED APPLICATION

This application claims the benefit of U.S. Provisional Patent Application No. 63/161,606 filed on Mar. 16, 2021, entitled “Apparatus and Method for Biometric Identification using the Mottling Pattern of the Skin,” which is hereby incorporated by reference in its entirety for all that is taught and disclosed therein.

### FIELD OF THE INVENTION

The present invention relates to subject authentication and identification, and more particularly to a system and method of biometric identification of a subject based on the unique capillary bed pattern present in the dermis of the palm of the hand and/or other body parts.

### BACKGROUND AND SUMMARY OF THE INVENTION

Biometric systems have been widely used for user identification and authentication based on measuring, recording, and matching certain unique characteristics of a human body. The biometric system will grant access upon matching a human with an electronically-stored credential. That access may be physical (unlocking a door or turnstile or safe or the like), or logical (granting access to a computer, a mobile device, a website, an online account, or the like).

Fingerprints, face, iris of the eye, retina of the eye, and large hand veins are body features that are measurably different from person to person. Images or digital representations of those features can be captured, stored, and later matched using existing biometric systems. Each of these has drawbacks, including limited accuracy, complexity of reading apparatus, ability to be spoofed, and ease of use.

It is known to those skilled in the art of biometrics that there are several methods for reading identifiable characteristics of the human hand for purposes of performing a biometric authentication or identification of a person. Current biological characteristics used for biometric matching include fingerprint(s), hand geometry, large palm veins, palm creases, and palm ridges. Biometric matching systems that utilize these body characteristics disadvantages of being spoofed by molds, images, or use of deceased body parts, and/or requiring physical contact with the biometric reading device.

Therefore, a need exists for a new and improved system and method of biometric identification of a subject that enables improved reliability, accuracy, simplicity of apparatus, resistance to spoof attacks, and ease of use. In this regard, the various embodiments of the present invention substantially fulfill at least some of these needs. In this respect, the system and method of biometric identification of a subject according to the present invention substantially departs from the conventional concepts and designs of the prior art, and in doing so provides an apparatus primarily developed for the purpose of enabling improved reliability, accuracy, simplicity of apparatus, resistance to spoof attacks, and ease of use.

The present invention provides an improved system and method of biometric identification of a subject, and overcomes the above-mentioned disadvantages and drawbacks of the prior art. As such, the general purpose of the present invention, which will be described subsequently in greater detail, is to provide an improved system and method of biometric identification of a subject that has all the advantages of the prior art mentioned above.

To attain this, the preferred embodiment of the present invention essentially comprises the steps of providing a light source and an imager, positioning a subject hand palm facing the light source and imager, illuminating the palm with the light source, capturing an image of the palm, and determining characteristics of capillary beds in the image. The present invention may include the step of identifying the subject based on the characteristics of the capillary beds. The step of determining characteristics of capillary beds in the image may include determining locations of the capillary beds. The present invention may include the step of processing the image to filter image features of the palm other than the capillary beds. Processing the image to filter image features of the palm other than the capillary beds may include removing surface ridge pattern features and spatially filtering to remove detail with a frequency of less than a selected threshold. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is a side sectional view of the current embodiment of a system using a method of biometric identification of a subject constructed in accordance with the principles of the present invention in use identifying a subject's hand.

FIG. 2 is a flowchart of the method of biometric identification of a subject suitable for use by the system of FIG. 1.

FIG. 3 is a flowchart of an alternative embodiment of the method of biometric identification of a subject suitable for use by the system of FIG. 1.

FIG. 4 is a top view of the system using a method of biometric identification of a subject of FIG. 1.

FIG. 5 is a top view of a first alternative embodiment of the system and method of biometric identification of a subject.

FIG. 6 is a top view of a second alternative embodiment of the system and method of biometric identification of a subject.

FIG. 7 is a schematic view of the system using a method of biometric identification of a subject of FIG. 1 in use identifying a subject's hand.

FIG. 8 is an image of a subject's hand taken by the system using a method of biometric identification of a subject of FIG. 7

FIG. 9 is a schematic view of a third alternative embodiment of the system using a method of biometric identification of a subject in use identifying a subject's hand.

FIG. 10 is an image of a subject's hand taken by the third alternative embodiment of the system using a method of biometric identification of a subject of FIG. 9.

FIG. 11 is a schematic view of a fourth alternative embodiment of the system using a method of biometric identification of a subject in use identifying a subject's hand.

FIG. 12 is an image of a subject's hand showing the capillary bed pattern.

FIG. 13 is the image of a subject's hand of FIG. 12 after being subjected to background elimination and magnification correction.

FIG. 14A is the image of a subject's hand of FIG. 13 after enlargement of an area of the palm.

FIG. 14B is the image of a subject's hand of FIG. 13 after enlargement of an area of a fingertip.

FIG. 15A is the image of a subject's hand of FIG. 14A after contrast of the features in the capillary bed pattern of the area of the palm have been enhanced.

FIG. 15B is the image of a subject's hand of FIG. 14B after contrast of the features in the capillary bed pattern of the area of the fingertip have been enhanced.

FIG. 16A is the image of a subject's hand of FIG. 15A after further highpass filtering and sharpening to enhance the capillary bed pattern of the area of the palm and to deemphasize variations in illumination across the hand.

FIG. 16B is the image of a subject's hand of FIG. 15B after further highpass filtering and sharpening to enhance the capillary bed pattern of the area of the fingertip and to deemphasize variations in illumination across the hand.

FIG. 17A is the image of a subject's hand of FIG. 16A after further lowpass filtering and sharpening to enhance larger features of the capillary bed pattern of the area of the palm.

FIG. 17B is the image of a subject's hand of FIG. 16B after further lowpass filtering and sharpening to enhance larger features of the capillary bed pattern of the area of the palm.

FIG. 18A is the image of a subject's hand of FIG. 17A after the number of grayscale levels of the palm area has been reduced to three.

FIG. 18B is the image of a subject's hand of FIG. 18A showing just the bright spots on the palm area.

FIG. 18C is the image of a subject's hand of FIG. 18A showing just the dark spots on the palm area.

FIG. 19A is the image of a subject's hand of FIG. 17B after the number of grayscale levels of the fingertip has been reduced to three.

FIG. 19B is the image of a subject's hand of FIG. 19A showing just the bright spots on the fingertip.

FIG. 19C is the image of a subject's hand of FIG. 19A showing just the dark spots on the fingertip.

FIG. 20A is the image of subject's hand of FIG. 18A showing a mapping of feature points to the palm area image.

FIG. 20B is the image of subject's hand of FIG. 19A showing a mapping of feature points to the fingertip image.

FIG. 21A is an image of just the mapping of feature points of FIG. 20A for the palm area.

FIG. 21B is an image of just the mapping of feature points of FIG. 20B for the fingertip.

FIG. 22 is the image of a subject's hand of FIG. 20A next to the similarly processed image of the same hand taken days later.

FIG. 23A is a raw image of the entire underside of an index finger taken with polarizing filters placed over both the camera and the LED light source.

FIG. 23B is a raw image of the entire underside of an index finger taken without polarizing filters placed over both the camera and the LED light source.

FIG. 24A is the image of the entire underside of an index finger of FIG. 23A after the background and edges of the finger have been masked.

FIG. 24B is the image of the entire underside of an index finger of FIG. 23B after the background and edges of the finger have been masked.

FIG. 25A is the image of the entire underside of an index finger of FIG. 24A after contrast has been enhanced and equalized.

FIG. 25B is the image of the entire underside of an index finger of FIG. 24B after contrast has been enhanced and equalized. Bandpass filtering or sharpening has also been applied.

FIG. 26A is the image of the entire underside of an index finger of FIG. 25A after the image has been posterized to a smaller number of grayscales, in this case four gray scales.

FIG. 26B is the image of the entire underside of an index finger of FIG. 25A after mapping of the local bright spots.

FIG. 26C is the image of the entire underside of an index finger of FIG. 25A after mapping of the local dark spots.

The same reference numerals refer to the same parts throughout the various figures.

### DESCRIPTION OF THE CURRENT EMBODIMENT

An embodiment of the system using a method of biometric identification of a subject of the present invention is shown and generally designated by the reference numeral 10.

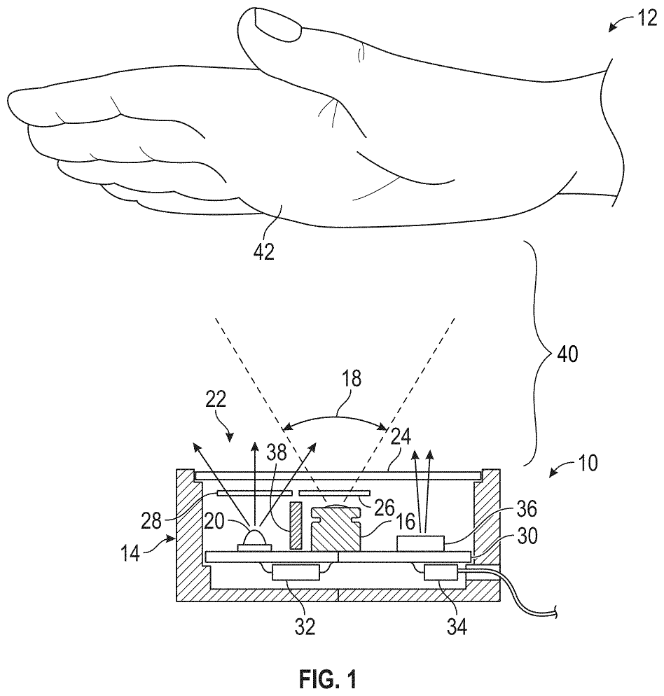

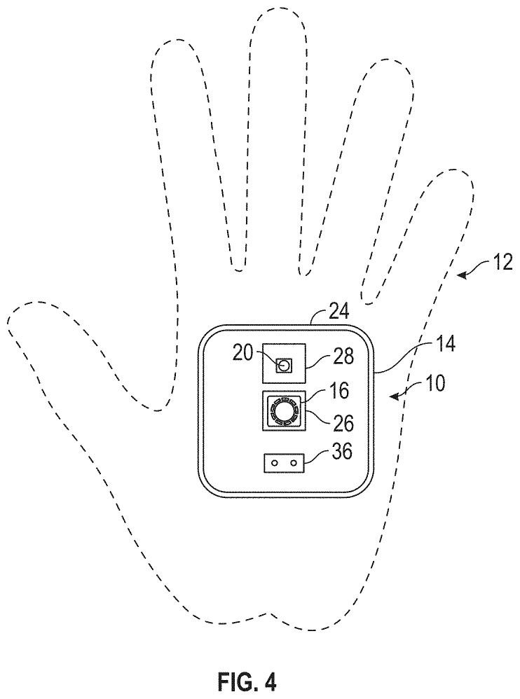

FIGS. 1 and 4 illustrate the improved system using a method of biometric identification of a subject 10 of the present invention. More particularly, FIG. 1 shows the system using a method of biometric identification of a subject (biometric identification system) in use identifying a subject's hand 12. The biometric identification system has an outer housing 14 containing a light source 20 operable to illuminate a skin surface 42 of a live subject (in this example, the subject's hand) spaced apart from the light source by a working distance 40 from the biometric identification system. The biometric identification system also includes a camera module 16 containing a CMOS image sensor, lens, and aperture operable to generate an image of the skin surface, and electronic components 32 including a processor operable to transmit and/or process the image. A polarizer 28 is located between the light source and the subject. The polarizer can be a circular polarizer located between both the light source and the camera module, and the subject, or the polarizer can be a first linear polarizer 28 having a first orientation between the light source and the subject, and a second linear polarizer 26 having the same first orientation or a different second orientation between the camera module and the subject. The skin surface can be illuminated with visible light, including illuminating with primarily green light. The skin surface can be illuminated with light having an energy spectrum mostly below a wavelength of 575 nm. The skin surface can be illuminated with light having a percentage energy content in the red and infrared wavelengths of less than 5%. The radiation pattern of the light source, which is an LED in the current embodiment, is denoted by 22. The contents of the outer housing are protected by a glass cover window 24. A printed circuit board 30 electrically connects and supports the light source, electronic components, a connector and cable 34 for power and communications, an optional proximity detector component 36, and an optional baffle to reduce stray light 38.

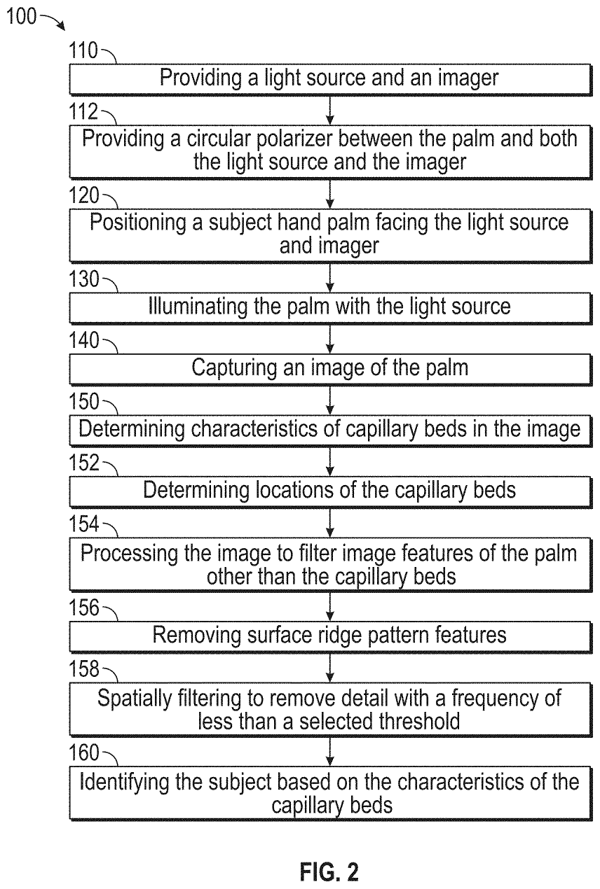

FIG. 2 illustrates the improved method of biometric identification of a subject 100 of the present invention. More particularly, the method includes the steps of providing a light source and an imager (110), positioning a subject hand palm facing the light source and imager (120), illuminating the palm with the light source (130), capturing an image of the palm (140), and determining characteristics of capillary beds in the image (150). The method can also include the step of identifying the subject based on the characteristics of the capillary beds (160). The step of determining characteristics of capillary beds in the image can include the step of determining locations of the capillary beds (152). The method can also include the step of processing the image to filter image features of the palm other than the capillary beds (154) before the step of identifying the subject based on the characteristics of the capillary beds. The step of processing the image to filter image features of the palm other than the capillary beds can include the step of removing surface ridge pattern features (156). The step of processing the image to filter image features of the palm other than the capillary beds can include the step of spatially filtering to remove detail with a frequency of less than a selected threshold (158), the selected threshold being less than 1 mm.

The step of illuminating the palm (130) can include illuminating with visible light, and illuminating with primarily green light. The step of illuminating the palm can also include illumination with light having an energy spectrum mostly below a wavelength of 575 nm. The step of illuminating the palm can also include illumination with light having a percentage energy content in the red and infrared wavelengths of less than 5%. The step of illuminating the palm can also include illumination with polarized light.

The step of providing a light source and an imager (110) can also include the step of providing a circular polarizer between the palm and both the light source and the imager (112). The step of capturing an image (140) can include capturing additional biometric feature information about the hand, the additional information biometric feature including at least one of hand periphery, surface ridges, fingerprints, minutiae, creases, and blood vessels. The step of capturing an image can also include the step of associating location information of the capillary beds with location information of the additional biometric feature information (142). A biometric match is determined based on location information of the subcutaneous features and location information of the additional biometric feature information. The step of positioning a subject hand palm facing the light source and imager (120) can include positioning the palm a small distance away from the light source and the imager, which could be a distance between 25 mm and 300 mm.

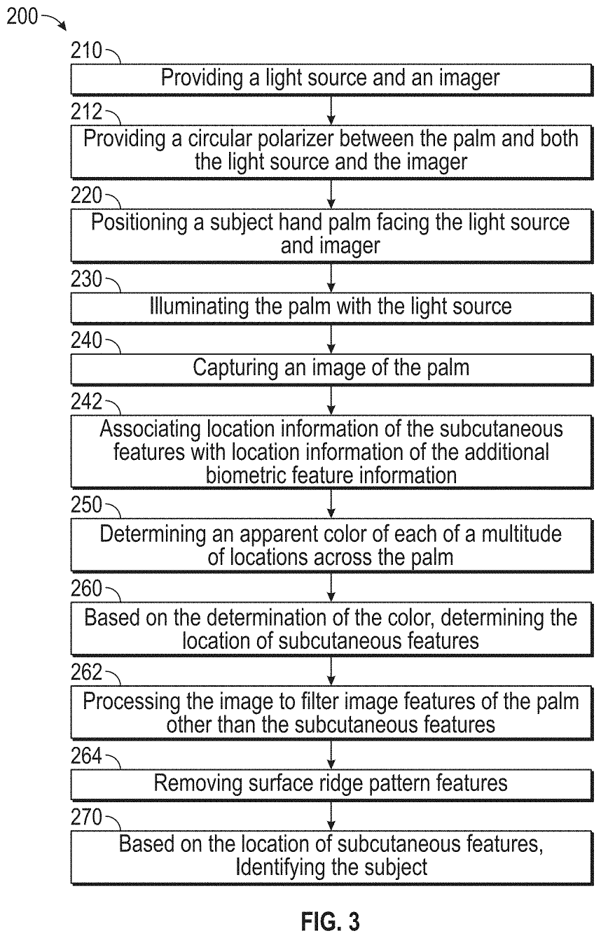

FIG. 3 illustrates an alternative embodiment of the improved method of biometric identification of a subject 200 of the present invention. More particularly, the method includes the steps of providing a light source and an imager (210), positioning a subject hand palm facing the light source and imager (220), illuminating the palm with the light source (230), capturing an image of the palm (240), determining an apparent color of each of a multitude of locations across the palm (250), based on the determination of the color, determining the location of subcutaneous features (260), and based on the location of subcutaneous features, identifying the subject (270). The step of determining the location of subcutaneous features can include limiting determination to features having a typical spacing of 1-10 mm. The step of determining the location of subcutaneous features can include limiting determination to features having mottled characteristics having insular minima or maxima. The step of determining the location of subcutaneous features can include limiting determination to avoid determination of features having elongated characteristics. Features having elongated characteristics can include visibly distinct veins and surface ridges.

The step of based on the determination of the color, determining the location of subcutaneous features (260) can include the step of processing the image to filter image features of the palm other than the subcutaneous features (262). The step of processing the image to filter image features of the palm other than the subcutaneous features can include the step of removing surface ridge pattern features (264).

The step of illuminating the palm (230) can include illuminating with visible light, and illuminating with primarily green light. The step of illuminating the palm can also include illumination with light having an energy spectrum mostly below a wavelength of 575 nm. The step of illuminating the palm can also include illumination with light having a percentage energy content in the red and infrared wavelengths of less than 5%. The step of illuminating the palm can also include illumination with polarized light.

The step of providing a light source and an imager (210) can also include the step of providing a circular polarizer between the palm and both the light source and the imager (212). It should be appreciated that the polarizer could also be linear. The step of capturing an image (240) can include capturing additional biometric feature information about the hand, the additional biometric feature information including at least one of hand periphery, surface ridges, fingerprints, minutiae, creases, and blood vessels. The step of capturing an image can also include the step of associating location information of the subcutaneous features with location information of the additional biometric feature information (242). A biometric match is determined based on location information of the subcutaneous features and location information of the additional biometric feature information. The step of positioning a subject hand palm facing the light source and imager (220) can include positioning the palm a small distance away from the light source and the imager, which could be a distance between 25 mm and 300 mm.

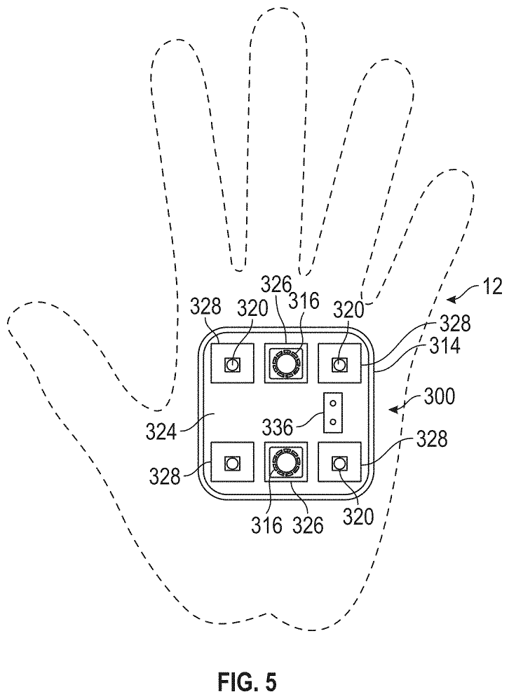

FIG. 5 illustrates a first alternative embodiment of the improved system using a method of biometric identification of a subject 300 of the present invention. More particularly, FIG. 5 shows the system using a method of biometric identification of a subject (biometric identification system) in use identifying a subject's hand 12. The biometric identification system 300 is identical to the biometric identification 10 except that the biometric identification system 300 utilizes two camera modules 316, each with a second linear polarizer 326, and four light sources 320, each with a first linear polarizer 328. Other components shown in FIG. 5 are the outer housing 314, glass cover window 324, and optional proximity detector 336. The use of two cameras may have one or more of the following advantages: ability to capture a larger area of the hand, ability to capture a hand that may be further off-center, ability to capture over a larger range of distance (one camera focused closer and one farther, for example), ability to determine distance and size (through parallax measurement), one camera may be optimized (in resolution, focus, or the like) for capturing the central palm area while the second is optimized for capturing the fingers, the two cameras may be optimized for different wavelengths of light (IR, visible, ultraviolet, for example) for multi-modal capture, and/or the two cameras having different optical filters or characteristic (polarization, wavelength sensitivity, etc.).

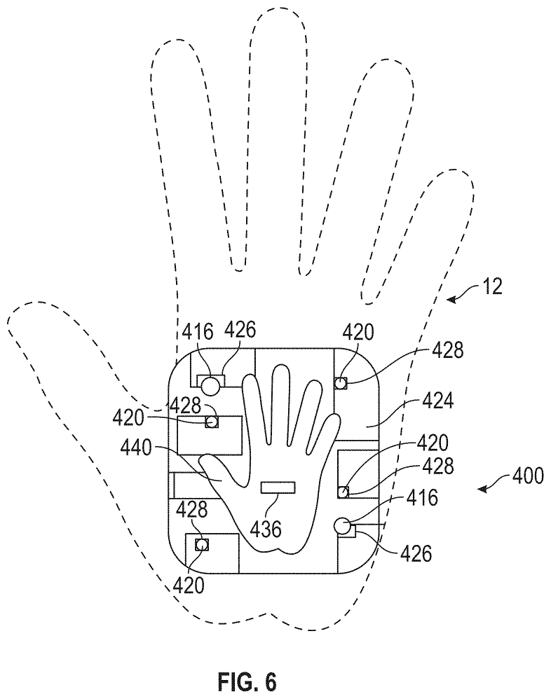

FIG. 6 illustrates a second alternative embodiment of the improved system using a method of biometric identification of a subject 400 of the present invention. More particularly, FIG. 6 shows the system using a method of biometric identification of a subject (biometric identification system) in use identifying a subject's hand 12. The biometric identification system 400 is identical to the biometric identification 10 except that the biometric identification system 400 utilizes two camera modules 416, each with a second linear polarizer 426, and four light sources 420, each with a first linear polarizer 428. Other components shown in FIG. 5 are the outer housing 414, glass cover window 424, and optional proximity detector 436. The glass cover window includes a hand icon 440 to inform and guide the user, and can have colors, filters, and/or coatings to make the camera modules, light sources, and other components less visible to the user.

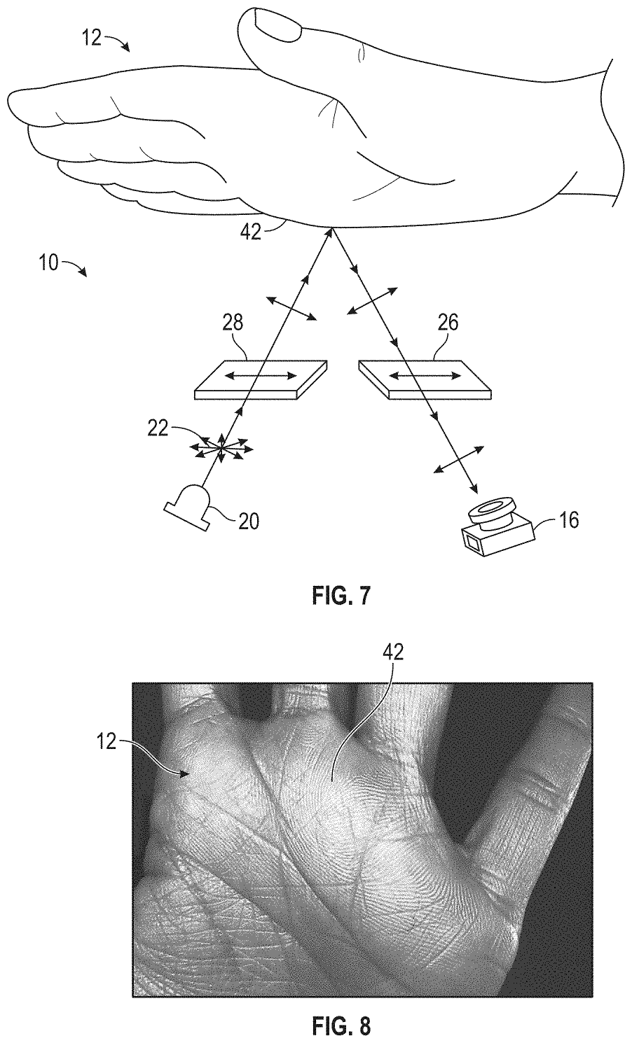

FIG. 7 illustrates the improved system using a method of biometric identification of a subject 10 of the present invention, and FIG. 8 shows the image captured by the camera module 16. More particularly, FIG. 7 shows the system using a method of biometric identification of a subject (biometric identification system) in use identifying a subject's hand 12. The biometric identification system is configured to highlight the surface profile of the skin surface 42 of a live subject's hand or finger. This configuration uses a first linear polarizer 28 between the light source 20 and the hand, and a second linear polarizer 26 (or an extension of the first linear polarizer) with a parallel axis of polarization to the first linear polarizer, between the hand and the camera module 16. The resulting image shown in FIG. 8 is dominated by specular reflection from the skin surface of the subject's hand.

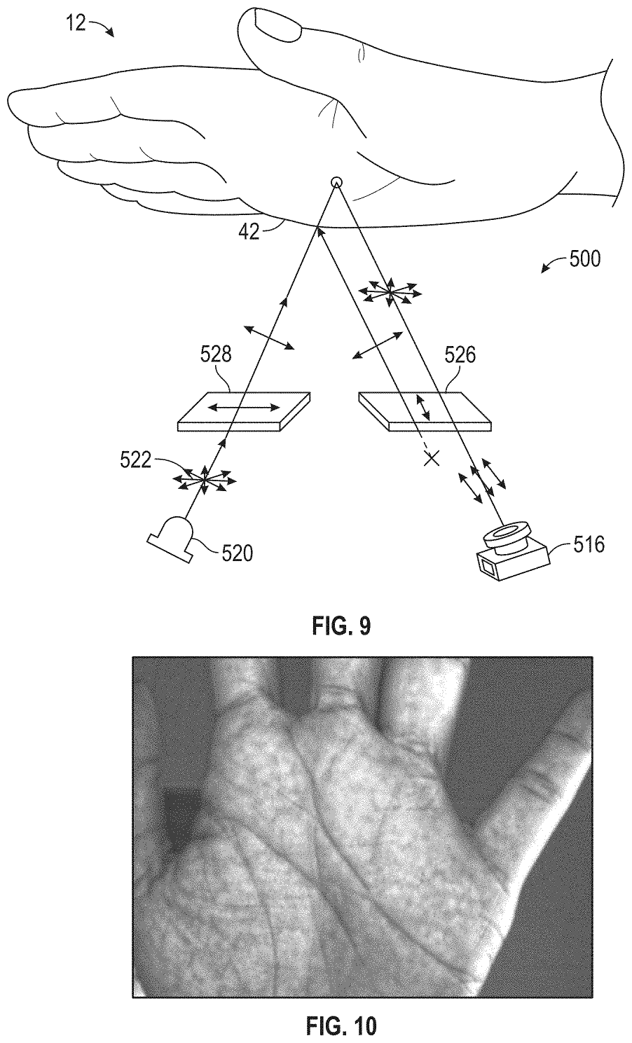

FIG. 9 illustrates a third alternative embodiment of the improved system using a method of biometric identification of a subject 500 of the present invention, and FIG. 10 shows the image captured by the camera module 516. More particularly, FIG. 9 shows the system using a method of biometric identification of a subject (biometric identification system) in use identifying a subject's hand 12. The biometric identification system is identical to the biometric identification system 10 except for being configured to suppress the specular reflection from the surface profile of the skin surface 42 of a live subject's hand or finger. This configuration uses a first linear polarizer 528 between the light source 520 and the hand, and a second linear polarizer 526 with a perpendicular axis of polarization to the first linear polarizer between the hand and the camera module. The resulting image shown in FIG. 10 is dominated by diffuse reflection from the flesh structures, such as capillary beds, of the subject's hand.

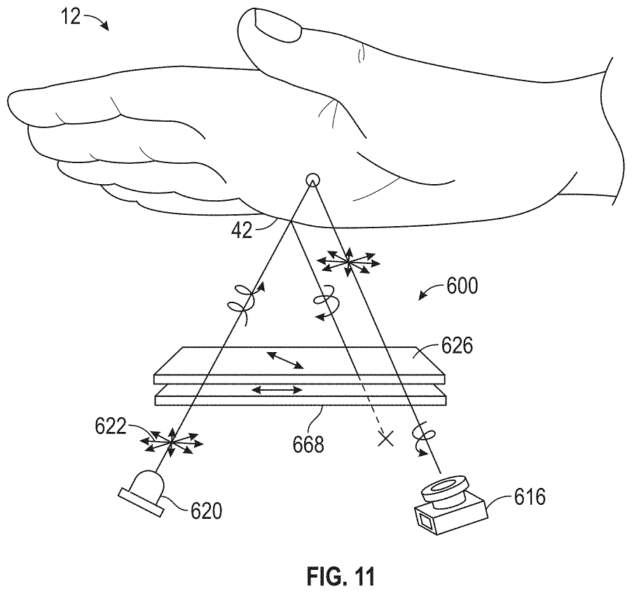

FIG. 11 illustrates a fourth alternative embodiment of the improved system using a method of biometric identification of a subject 600 of the present invention. More particularly, FIG. 11 shows the system using a method of biometric identification of a subject (biometric identification system) in use identifying a subject's hand 12. The biometric identification system is identical to the biometric identification system 10 except for being configured to suppress the specular reflection from the surface profile of the skin surface 42 of a live subject's hand or finger. This configuration uses a circular polarizer whose construction includes a linear polarizer layer 628 between the light source 620 and the hand, and a quarter wave plate layer 626 with an axis of polarization rotated 45° relative to the linear polarizer between the hand and the linear polarizer layer. In the embodiment shown, the circular polarizer also extends between the hand and the camera 616. The resulting image is dominated by diffuse reflection from the flesh structures beneath the topmost surface of the subject's hand. Specular reflection from the surface of the subject's skin retains circular polarization, but opposite “handedness.” Thus, the specular reflection is effectively blocked by the second pass through the circular polarizer before encountering the camera.

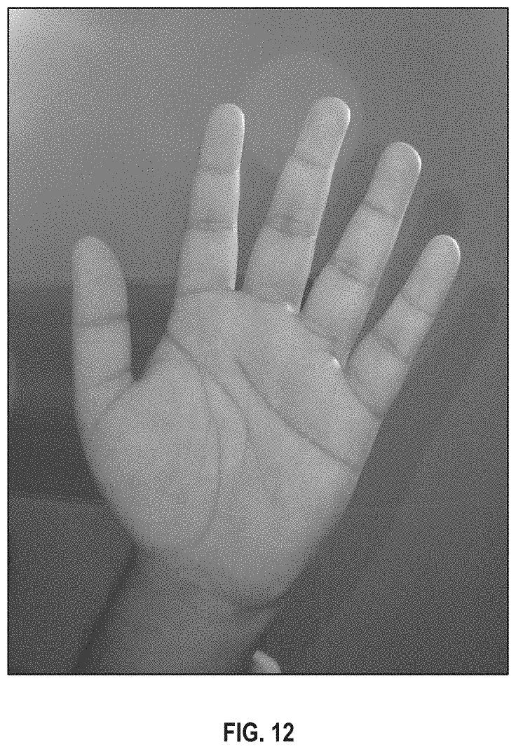

FIG. 12 illustrates a typical raw image of a subject's hand. In this example, the hand was illuminated with green LED light. Polarizing filters were placed over both the LED light source and the camera in order to enhance the image of the capillary bed pattern.

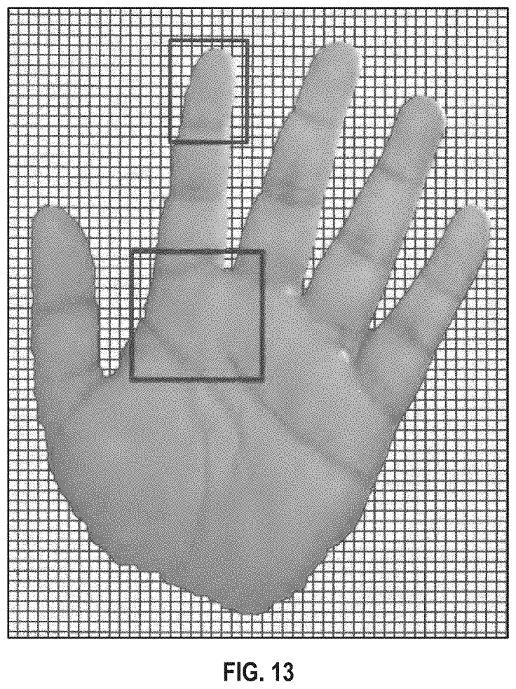

FIG. 13 illustrates the image of a subject's hand of FIG. 12 after being subjected to background elimination and magnification correction. Background may be subtracted by thresholding, color filtering, or subtraction of a non-illuminated image taken in fast succession. Background is indicated by square pattern shown, and this area is ignored in subsequent processing steps. It may be advantageous to eliminate the edges of the hand from analysis, as the curvature, ambient reflections, and shadows there make feature recognition difficult.

Magnification correction may adjust for different hand distances through use of either a proximity sensor or two cameras and parallax computation. Alternatively, all hand images may be magnified to a standard distance between key points.

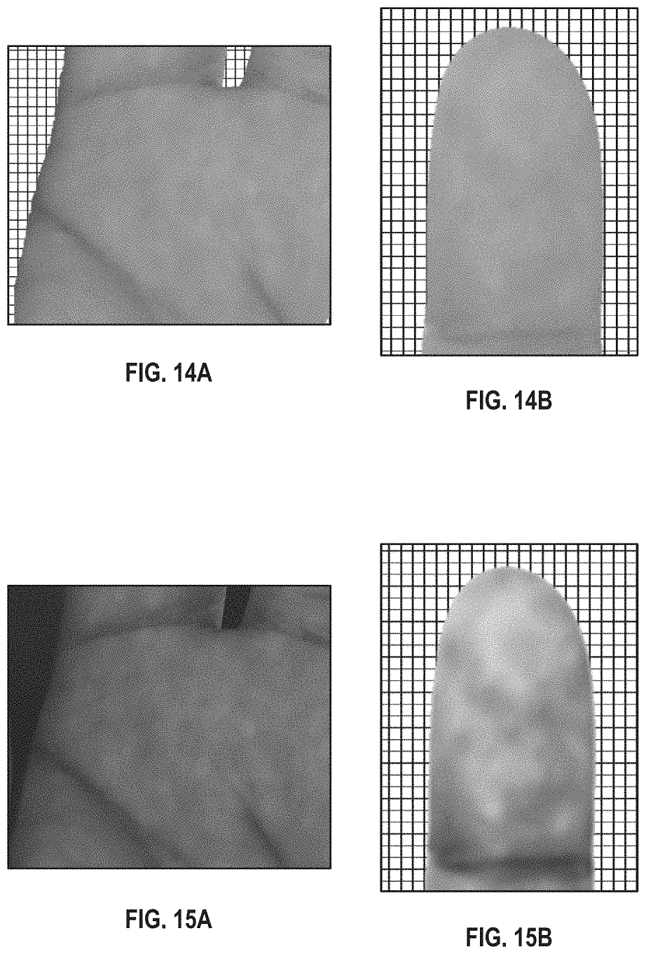

FIG. 14A illustrates the image of a subject's hand of FIG. 13 after enlargement of an area of the palm.

FIG. 14B illustrates the image of a subject's hand of FIG. 13 after enlargement of an area of a fingertip. The image of the fingertip has also been rotated.

FIG. 15A illustrates the image of a subject's hand of FIG. 14A after contrast of the features in the capillary bed pattern of the area of the palm have been enhanced by image processing steps.

FIG. 15B illustrates the image of a subject's hand of FIG. 14B after contrast of the features in the capillary bed pattern of the area of the fingertip have been enhanced by image processing steps.

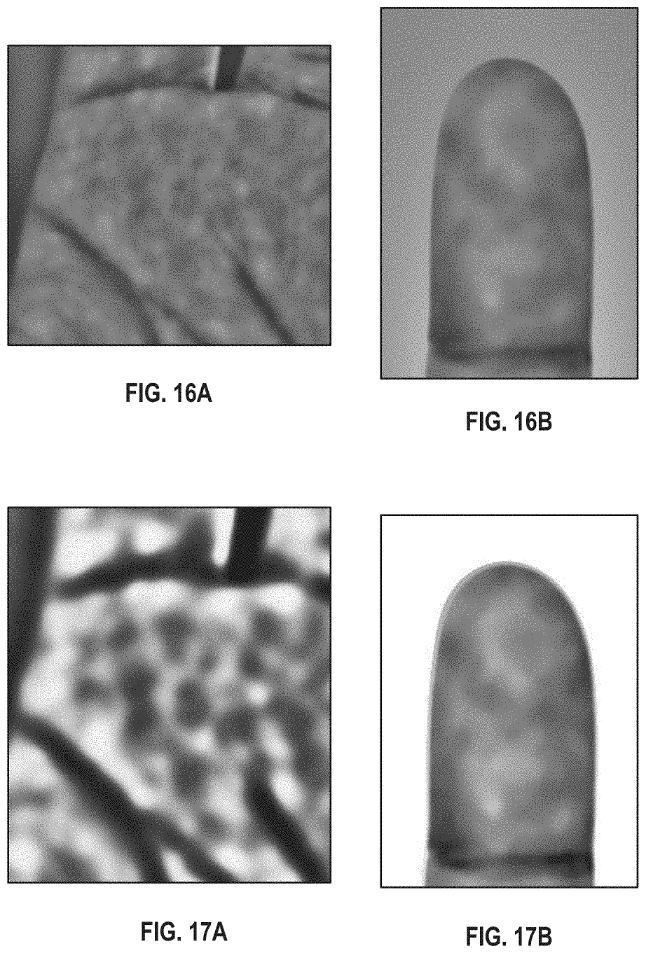

FIG. 16A illustrates the image of a subject's hand of FIG. 15A after further highpass filtering and sharpening to enhance the capillary bed pattern of the area of the palm and to deemphasize variations in illumination across the hand.

FIG. 16B illustrates the image of a subject's hand of FIG. 15B after further highpass filtering and sharpening to enhance the capillary bed pattern of the area of the fingertip and to deemphasize variations in illumination across the hand.

FIG. 17A illustrates the image of a subject's hand of FIG. 16A after further lowpass filtering and sharpening to enhance larger features of the capillary bed pattern of the area of the palm. It may be unnecessary to preserve all the small features, as it will be more reliable and computationally efficient to perform a match based on the larger (in area and/or amplitude) features of the capillary bed pattern. Therefore, low pass filtering (gaussian blurring, e.g.) may be performed. This will also eliminate high frequency noise (dust, ridge patterns, dirt, etc.) Additionally, sharpening or equalization (histogramic equalization, e.g.) will stretch the dynamic range to make full use of all the grayscales from black to white.

FIG. 17B illustrates the image of a subject's hand of FIG. 16B after further lowpass filtering and sharpening to enhance larger features of the capillary bed pattern of the area of the palm. It may be unnecessary to preserve all the small features, as it will be more reliable and computationally efficient to perform a match based on the larger (in area and/or amplitude) features of the capillary bed pattern. Therefore, low pass filtering (gaussian blurring, e.g.) may be performed. This will also eliminate high frequency noise (dust, ridge patterns, dirt, etc.) Additionally, sharpening or equalization (histogramic equalization, e.g.) will stretch the dynamic range to make full use of all the grayscales from black to white.

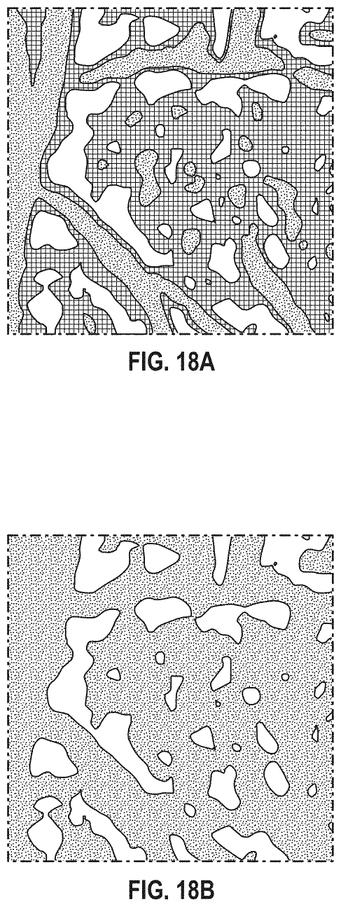

FIG. 18A illustrates the image of a subject's hand of FIG. 17A after the number of grayscale levels of the palm area has been reduced to three. FIG. 18B illustrates the image of a subject's hand of FIG. 18A showing just the bright spots on the palm area. FIG. 18C illustrates the image of a subject's hand of FIG. 18A showing just the dark spots on the palm area. Although the previous images can be usable for matching, the number of grayscales may be reduced to allow for a smaller data size of the stored information. FIG. 18A has been “posterized,” reducing the number of grayscale levels to 3, yet the key minima and maxima shapes and locations are preserved. FIGS. 18B & C are subimages of just the bright and dark spots of the posterized image. Any of these images can be used for matching. Note that edge areas of the hand may be excluded as these areas are affected by shadows, ambient light reflections, and curvature of the skin and therefore are of little value in providing useful features for matching.

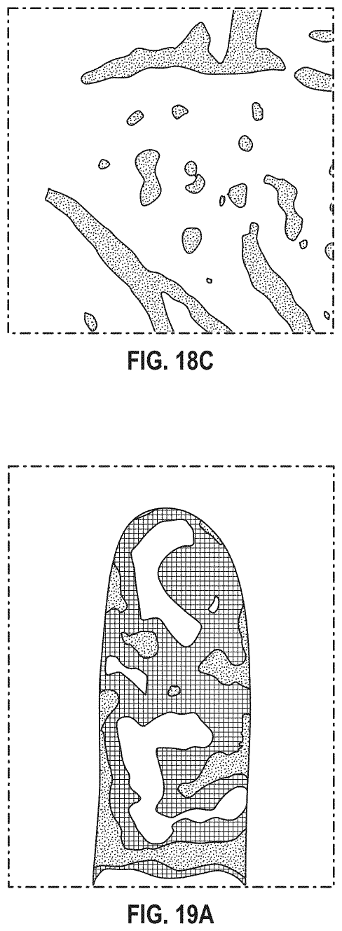

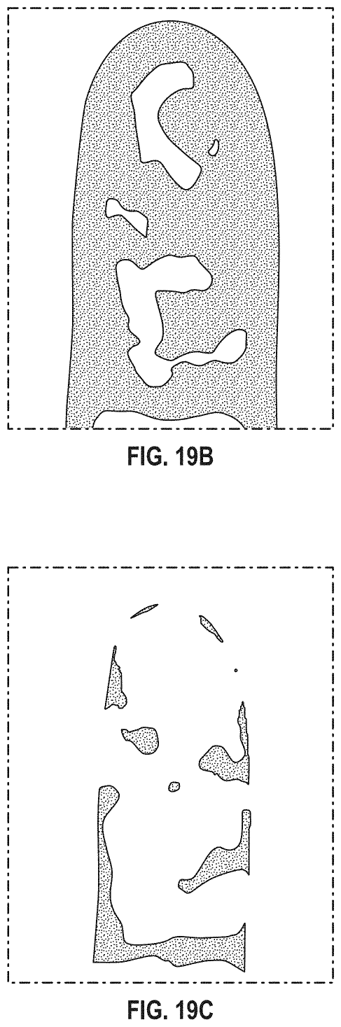

FIG. 19A illustrates the image of a subject's hand of FIG. 17B after the number of grayscale levels of the fingertip has been reduced to three. FIG. 19B illustrates the image of a subject's hand of FIG. 19A showing just the bright spots on the fingertip. FIG. 19C illustrates the image of a subject's hand of FIG. 19A showing just the dark spots on the fingertip. Although the previous images can be usable for matching, the number of grayscales may be reduced to allow for a smaller data size of the stored information. FIG. 19A has been “posterized,” reducing the number of grayscale levels to 3, yet the key minima and maxima shapes and locations are preserved. FIGS. 19B & C are subimages of just the bright and dark spots of the posterized image. Any of these images can be used for matching. Note that edge areas of the fingertip may be excluded as these areas are affected by shadows, ambient light reflections, and curvature of the skin and therefore are of little value in providing useful features for matching.

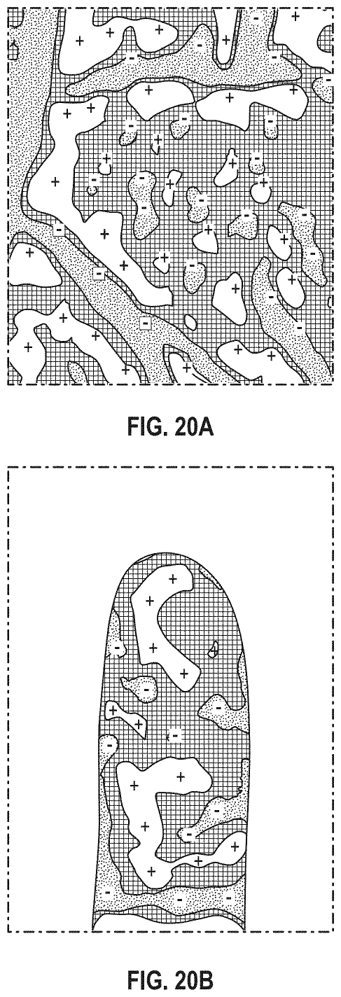

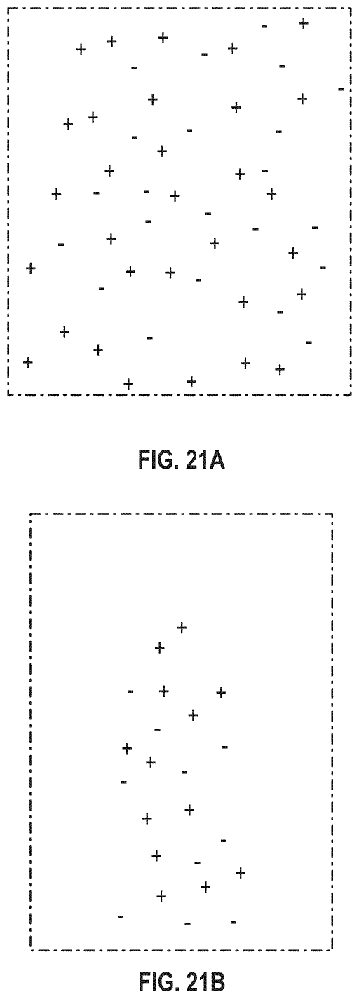

FIG. 20A illustrates the image of subject's hand of FIG. 18A showing a mapping of feature points to the palm area image. FIG. 21A illustrates an image of just the mapping of feature points of FIG. 20A for the palm area. Instead of saving an image as shown previously for matching, it can be advantageous to store a mapping of minima and maxima points. This method of feature points mapping further reduces data storage requirements and can speed up matching. In the figures shown, “+” marks are placed at local maxima points and “−” marks are placed at the local minima points, for the palm area image.

The procedure to assign and map the feature points can include criteria such as: minimum area requirement, minimum proximity to another point, different treatment of strings of contiguous low or high brightness features. The points can be chosen to be in the centroid of each splotch, and larger splotches may get multiple points according to some criteria. Additionally, each point can be assigned a ‘weighting’ value dependent on the amplitude of the signal, the area of the surrounding minima/maxima, confidence value, and/or other criteria. The stored feature data can be a string of cartesian x-y locations (and type, and ‘weighting’ value, etc.) measured from some predictable “zero” position, or can be a string of offset vectors from a neighboring point.

FIG. 20B is the image of subject's hand of FIG. 19A showing a mapping of feature points to the fingertip image. FIG. 21B illustrates an image of just the mapping of feature points of FIG. 20B for the fingertip. Instead of saving an image as shown previously for matching, it can be advantageous to store a mapping of minima and maxima points. This method of feature points mapping further reduces data storage requirements and can speed up matching. In the figures shown, “+” marks are placed at local maxima points and “−” marks are placed at the local minima points, for the fingertip image.

The procedure to assign and map the feature points can include criteria such as: minimum area requirement, minimum proximity to another point, different treatment of strings of contiguous low or high brightness features. The points can be chosen to be in the centroid of each splotch, and larger splotches may get multiple points according to some criteria. Additionally, each point can be assigned a ‘weighting’ value dependent on the amplitude of the signal, the area of the surrounding minima/maxima, confidence value, and/or other criteria. The stored feature data can be a string of cartesian x-y locations (and type, and ‘weighting’ value, etc.) measured from some predictable “zero” position, or can be a string of offset vectors from a neighboring point.

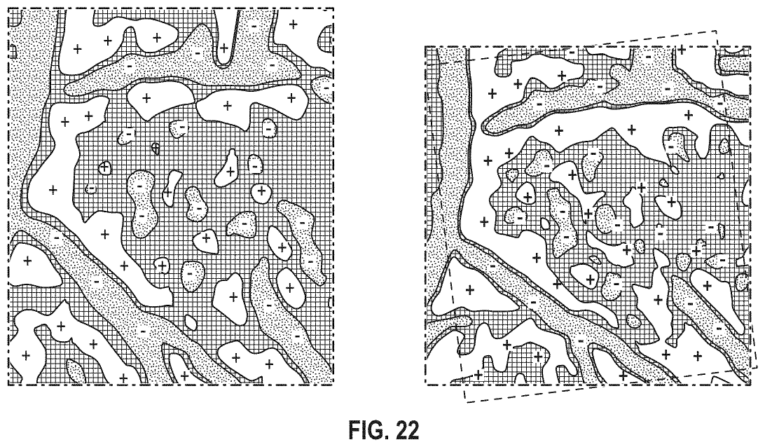

FIG. 22 illustrates the image of a subject's hand of FIG. 20A next to the similarly processed image of the same hand taken days later. The process of initial registration of a subject's biometric data may follow image processing and storage steps such as described previously. The biometric data, preferably in a compressed format, is stored on a server, on a computer, in a mobile device, or on some other data storage device. At a time or times in the future, the user again places their hand over an image capture apparatus, and the biometric features (the capillary bed pattern) are again captured, possibly using image processing steps such as outlined previously. Then a computer must compare the newly captured “verification” data to the initially stored “registration” data to determine if there is a match. A mathematical match will confirm that the same person is seeking authorization.

FIG. 22 is the processed subimage of FIG. 20A with the feature points mapped, next to the similarly processed subimage of the same hand taken days later. Of course, the captured capillary bed pattern is not identical, yet the overlaid feature map from the original image (with some rotation and magnification adjustment) shows a high degree of correlation to the new image's minima and maxima spots.

The matching process may take many forms. Some examples are:

1. A straight full-image similarity scan. Preferably the verification image will be translated in x and y, rotated by an angle, and stretched in x and y such that the image is at the same size and position as the registration image. This can be achieved by forcing key ‘anchor points’ to overlap. Such ‘anchor points’ may be outline of the fingers, major palm creases, or the like. Grayscale may be normalized to account for different illumination between time of registration and verification. Then a pixel-by pixel similarity function can be performed; such similarity function may be mathematical difference or the like. The sum of all the differences will give a measure of the similarity of the images. If the sum is less than some threshold, a match can be declared.

2. A similarity scan similar to the first process, but working on the “posterized” image that has been filtered, reduced to a smaller number of grayscales, and equalized as described previously. Again, some translation, rotation, and stretching of the image can be performed to get the images to overlap. Then a pixel-by-pixel similarity function can be performed and a score computed which represents how closely the capillary bed pattern of the verification image matches the registration image.

3. A matching process whereby the registration key feature points (local maxima and minima of the capillary bed pattern captured during registration) are overlaid onto the verification capillary bed pattern image and a mathematical scoring is performed which represents the degree to which the registration key feature points match relatively brighter and darker spots in the verification image.

4. A similarity scoring procedure whereby the raw image, or the posterized/equalized image, or the feature point map or a subset of such image/map undergoes an auto-correlation or convolution step. As known to one skilled in the art, auto-correlation or convolution or the like consists of measuring the degree of similarity of one mathematical array (which may be image data) to a second mathematical array as one array is translated (in x and or y), and/or rotated, and or stretched. At some point, the autocorrelation or convolution function reaches a maximum which would represent the position (x, y), rotation, and stretching needed for one of the arrays to most closely match the second array. If even at the maximum of that function the function returns a low correlation factor, it can be concluded the two arrays do not match, and in this case that the two biometric capillary bed patterns do not originate from the same physical hand.

These four methods describe geometrical/mathematical steps for measuring the degree of match between the registration and verification images. An alternative method would be to use “machine learning,” or “artificial intelligence” or “neural network” techniques to determine the match confidence. As one skilled in the art knows, such techniques involve training classifiers on very large data sets to configure a system. Although the root calculations in such a system are complex and/or unknown, the resulting system can be highly accurate and adaptable over time.

The four processes may preferably be performed on smaller subsets of the image, possibly 10×10 or 20×20 mm square areas or the like. These smaller areas have a higher likelihood of mathematically matching the corresponding area of the second image than a whole-hand match, especially if the hand image data has differences in rotation, position, distance, hand “cupping,” illumination, blemishes, etc.

Furthermore, instead of autocorrelating each verification subimage over the entire hand, it would be more computationally efficient to autocorrelate each subimage over the expected region, +/−20 mm or so, and over an expected rotation, as determined by anchor points such as hand edge, base of fingers, angle of fingers, large crease pattern, or the like. A matching hand can have a significant majority of the subimages match with strong scores and predictable relative positions.

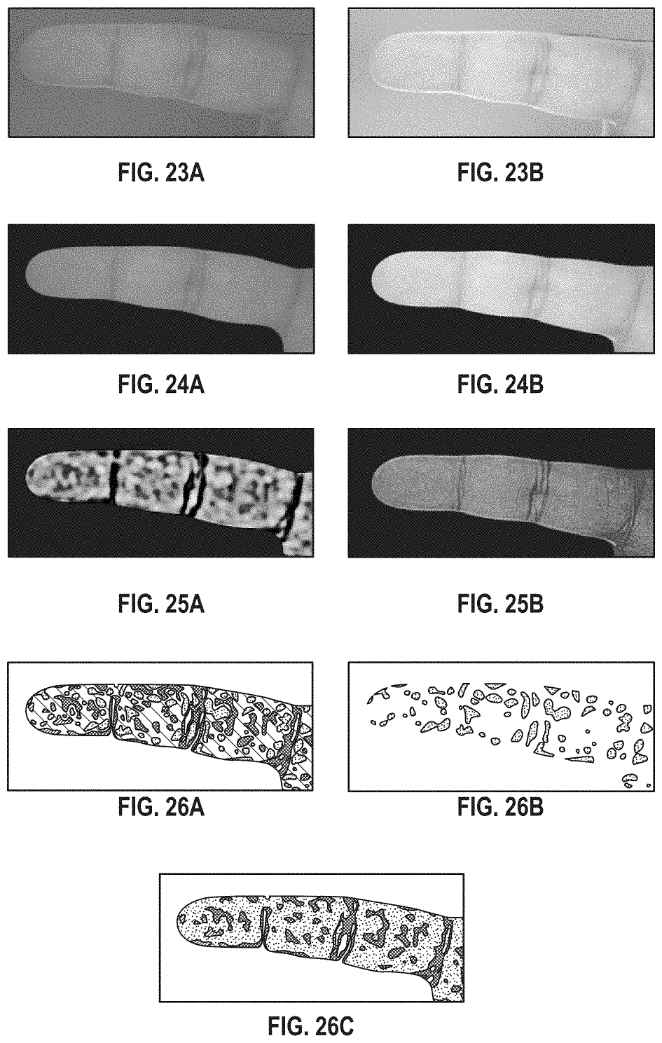

FIG. 23A is a raw image of the entire underside of an index finger taken with polarizing filters placed over both the camera and the LED light source. The polarizing filters block specular reflection from the finger ridges, thereby making the diffuse reflection from the capillary bed pattern more pronounced.

FIG. 23B is a raw image of the entire underside of an index finger taken without polarizing filters placed over both the camera and the LED light source. Compared to FIG. 23A, it is apparent that the absence of the polarizing filters results in more pronounced specular reflection from the finger ridges.

FIG. 24A is the image of the entire underside of an index finger of FIG. 23A after the background and edges of the finger have been masked.

FIG. 24B is the image of the entire underside of an index finger of FIG. 23B after the background and edges of the finger have been masked.

FIG. 25A is the image of the entire underside of an index finger of FIG. 24A after contrast has been enhanced and equalized.

FIG. 25B is the image of the entire underside of an index finger of FIG. 24B after contrast has been enhanced and equalized. Bandpass filtering or sharpening has also been applied.

FIG. 26A is the image of the entire underside of an index finger of FIG. 25A after the image has been posterized to a smaller number of grayscales, in this case four gray scales. The posterized image highlights local minima and maxima splotches in the pattern.

FIG. 26B is the image of the entire underside of an index finger of FIG. 25A after mapping of the local bright spots.

FIG. 26C is the image of the entire underside of an index finger of FIG. 25A after mapping of the local dark spots.

The various embodiments of the system using a method of biometric identification of a subject can be used to identify a subject from their hand palm or their fingers. The biometric identification system reads the pattern of vascular mottling of the human flesh and/or skin, and makes a biometric comparison of this pattern to a stored representation of the pattern, in order to authenticate, identify, and/or match a person. The preferred use of the invention is to read the vascular mottling pattern of the palm of the hand and/or underside of fingers. However, this invention could be used for other parts of the human body. Furthermore, it should be appreciated that the term “palm” is used broadly to indicate any portion of the hand surface having ridges and valleys, including the central palm, and fingers to the tips, and associated with colloquial usage such as a “palm print” and “palm reading” or palmistry that are not limited to the central area away from the fingers.

The vascular mottling pattern appears as a random pattern of faint, irregularly-shaped spots or splotches of lighter pink (or almost white) and darker pink, generally 0.5-3 mm in width or diameter in the skin of the palm. This characteristic is referred to in biological and medical literature as vascular mottling and is similar to, or may be alternatively defined as: capillary beds, Bier spots, angiospastic macules, livedo reticularis, or physiologic anemic macules (although some of those definitions are used for extreme mottling associated with disease.) The darker pink areas of the vascular mottling pattern are likely due to capillary beds of small blood vessels or capillaries in the dermis layer of the skin, below the epidermis layer. The lighter pink areas of the vascular mottling pattern arise from regions of lower concentration of capillaries, smaller thickness of capillary-rich layers, or relative absence of capillaries such that the underlying lighter-colored cell structures show through. The lighter-colored structures are likely fat cells, elastin, collagen, and/or other fibrous connective tissue that make up the dermis layer. The terms “vascular mottling pattern” and “capillary bed pattern” both describe the same characteristic of the human palm and may be used interchangeably. For simplicity, the term “capillary bed pattern” will be primarily used.

The palm of the hand is especially well-suited for imaging the capillary bed pattern because of: lack of hair, hair follicles and other associated structures, as well as the presence of tissue such as the stratum lucidum. The stratum lucidum (Latin for “clear layer”) is a thin, clear layer of dead skin cells in the epidermis named for its translucent appearance under a microscope. If pressure is applied to a small area on the palm, the skin there temporarily turns from deep pink to lighter pink or white because red-colored blood is forced out of the capillary beds. This effect is called “blanching.” Blanching temporarily obscures the capillary bed pattern. However, within a few seconds after pressure is released, blood returns to those capillaries and the same capillary bed pattern can again be seen. This phenomenon illustrates that the mottling pattern is primarily vascular in nature.

The structures in the flesh that give rise to the capillary bed pattern are generally 0.5 mm to 3 mm below the surface of the skin, and do not give rise to any 3-dimensional profile on the surface of the skin. Thus, the capillary bed pattern is distinctly different from palm ridges, warts, callouses, creases, and the like. It is also distinctly different from capillary blood vessels in the papillary loops of the upper papillary layer, as those follow the fingerprint-like pattern of surface ridges. The capillary bed pattern has little to no correlation with the surface ridge pattern, the crease pattern, or the large vein patterns of the hand.

In particular, the mottled splotch characteristic of the capillary beds in the palm is distinctly different from the branch-like structure of the large veins and arteries which tend to be deeper below the surface of the palm of the hand. The capillary bed pattern is made up of discrete splotches in random placement while the large veins are made up of interconnected lines in a branch-like structure. The capillary bed pattern in the palm is visible or faintly visible to the naked eye under visible light illumination whereas the large blood vessels in the palm are nearly or entirely invisible to the naked eye under visible light illumination. Infrared light (IR) and an IR-sensitive camera system must be used to capture an image of the large palm veins, whereas the capillary bed pattern is largely invisible to an IR-sensitive camera system under IR illumination.

The capillary bed pattern is visible under visible-wavelength light, especially when using blue or green or blue-green illumination sources. The capillary bed pattern can even be seen by the naked eye, although it is usually faint. The effectiveness of blue-green light is because light of these wavelengths is relatively more absorbed by blood in areas of higher capillary concentration in the capillary beds, yet light of these wavelengths is relatively more reflected by collagen-rich flesh (and other tissue) in areas of lower capillary density.

The capillary bed pattern can also be seen when the hand is illuminated by ultraviolet light. The underlying collagen-rich tissue in the normally light pink or white areas fluoresce slightly when illuminated by UV-A light (315-400 nm), emitting some blue light, while the blood-rich capillaries in the normally deep pink or reddish areas remain dark because they are relatively more absorbent of ultraviolet light and/or the substantially blue light emitted by the underlying fluorescing tissue. An ultraviolet-rejecting longpass optical filter may be fitted over the imager to block the reflection of ultraviolet light while passing the fluorescence signal in the visible wavelength range. This would negate the need for polarizing filters to block surface reflection, such polarizers being difficult and/or expensive to fabricate for ultraviolet wavelengths.

The capillary bed pattern may be somewhat more noticeable if the hand is cold and/or held below the waist. Increased blood concentration in the capillary beds results from the effects of vasodilation and/or gravity, respectively. The spots or splotches may appear clearly, or may be virtually invisible to the human eye, depending on factors including: temperature, disease, ambient light, and whether the body part is raised or lowered. Nevertheless, the shapes, patterns, and relative locations of the spots or splotches are measurable by an optical/electronic apparatus, are unique to a person, and remain relatively constant over time for that person. This makes the trait useful for biometric identification. The capillary bed pattern has several advantages over other hand biometric features, including: increased number of features that can be identified, increased recognition accuracy, non-contact usage mode, less sensitivity to hand position, compact/lower cost hardware, inherent privacy, and resistance to spoof attacks. There are potentially many more identifiable features in the capillary bed pattern than in other hand biometric systems such as hand outline geometry, palm crease patterns, and the typical infrared imaging of the large palm veins. There are typically more than one hundred features suitable for identification in the capillary bed pattern of the palm, each with a characteristic shape, relative intensity, and location. This increased quantity of identifiable features allows for higher accuracy biometric matching.

Biometric readers may be categorized into two types: “contact” (“touch”) readers and “non-contact” (“touchless”) readers. Contact readers require the user to place the part of the skin to be identified in physical contact with a surface of the reader, whereas non-contact readers can read the person's body part at some distance through air. Touch readers have the advantages of a fixed focal distance to the skin, less variation of presentation angle, and/or an inherent conversion of a 3D surface to a 2D plane. Non-contact readers have the advantages of a more hygienic usage methodology, the ability for a relatively small reader to capture the image of a relatively larger area of the body, compatibility with non-flat and/or sensitive body parts, and the skin not blanching from the pressure of contact with the reader. Blanching is the whitening of the skin in contact with a surface due to the evacuation of blood from the capillaries because of the applied pressure.

This invention has application to both contact and non-contact biometric readers. For example, a contact fingerprint reader could read the capillary bed pattern of the fingertip, possibly in conjunction with reading the conventional fingerprint ridge pattern. Such a reader would have to read the capillary bed pattern immediately as the finger comes in contact with the reader, or slightly before contact, so as not to have the blanching effect obscure the pattern. However, it is envisioned that the greatest applicability of this invention is for a non-contact reader, particularly a non-contact palm and finger reader. Such a reader will have convenience, ease-of-use, accuracy, hygiene, and disease-prevention advantages compared to a contact reader.

Non-contact palm ridge capture systems tend to be heavily dependent on the viewing angle of the camera and illumination angle(s) of light source(s) relative to the hand, making it difficult to capture complete and clear ridge data from the entire palm's contoured surface. Dry and worn hands further obscure the palm ridge pattern. In contrast to palm ridges, the capillary bed pattern's image can be captured more easily and reliably even if the hand is wet, dry, or presented at somewhat different angles to the imaging system.

Biometric systems based on the capillary bed pattern have privacy and anti-spoof advantages for the user because of the difficulty of surreptitiously acquiring the capillary bed pattern of an unwilling individual. In contrast, latent fingerprints and handprints can be lifted from a touched surface without requiring the subject to even be present. The capillary bed pattern of the hand leaves no latent pattern or imprint when the user touches a surface or holds an item. Moreover, facial images can be captured from long distance cameras or acquired from social media internet sites.

There is a strong need in the industry to make biometric systems highly resistant to spoof attacks. Such spoofs may take the form of photocopies of a body part, printed patterns of a body part, a latex or silicone mold of a body part, or a computer/mobile screen displaying an image of a body part. For the reasons cited above, it is extremely difficult for a hacker to “lift” or surreptitiously copy the capillary bed pattern of a person they wish to impersonate to the biometric system. Even in the unlikely case that a hacker obtained the image of a person's capillary bed pattern, it would be difficult to replay that information to a reader because of hardware and software safeguards. Such safeguards include, but are not limited to, methods to detect an image is coming from a digital screen through detection of pixels, polarizers, incorrect reflectivity to different wavelength light, methods to detect an image is printed on paper or film through detection of pixels, artificial colors, incorrect reflectivity under different wavelength or different polarized light sources, and methods to detect a 3-dimensional model of a hand through detection of incorrect responses to different light wavelengths or polarized light. If the capillary bed pattern reader of this invention additionally has the capability to capture the palm ridge pattern and/or the large palm vein pattern, then this invention can further increase the difficulty of spoofing the system. This would be enabled by determining those secondary characteristics (palm ridges, large palm vein) are present on the presented hand or spoof, and/or are substantially similar in location, shape, and/or orientation to those features stored at the time of biometric registration.

A preferred embodiment of this invention reads and matches the capillary bed pattern of the palm of the hand. That is because it is envisioned that a biometric hand palm scanner would be a convenient and high-accuracy application of the invention. The capillary bed pattern is most clear in the hand area, where it is generally not obscured by hair, follicles, freckles, dark melanin, and other features that obscure the capillary bed pattern. Nevertheless, it is envisioned that the invention might also be applied to other parts of the human body, including but not limited to the palm-side fingers of the hand, the fingertips of the hand, the back (non-palm side) of the hand, the back side fingers of the hand, the wrist, the face, and the ears. For example, reading the capillary bed pattern of the fingers of the hand may be somewhat more consistent than reading the palm area, which may be wrinkled, cupped, or warped depending on the shape, gesture, or position of the hand. For simplicity, the descriptions here are primarily worded around use of this invention as applied to the palm of the hand and the palm-side fingers of the hand.

The invention may take the form of a dedicated apparatus for illuminating and imaging the capillary bed pattern, or it may utilize an existing camera in a device such as a mobile phone, tablet, or personal computer. In those latter instances, the invention takes the form of a method, implemented in software, to process and match the mottling image as captured using the built-in camera.

To those skilled in the art, the term “authentication” and particularly “biometric authentication” refers to the one-to-one comparison of a presented biometric trait to a single stored representation of that trait. If the biometric data matches, the person is granted physical or logical access. Alternatively, the term “identification” and particularly “biometric identification” refers to the one-to-many comparison of a presented biometric trait to a plurality of stored representations of that trait with the purpose of identifying whether the individual present is in the stored database, and/or identifying which individual in a database is present, and/or granting access to the individual present upon confirming their credential is in the database. The invention described here is applicable to both biometric authentication and biometric identification. For simplicity, the terms “biometric match” and “biometric matching” will be used to refer to all manner of biometric authentication and biometric identification.

This invention uses optical technology, such as an electronic camera system, to capture an image of the capillary bed pattern. The electronic camera system typically employs a CCD or CMOS image sensor, a lens, and an aperture to record a digital image. Preferably, an illumination system using blue-green LEDs is used; however, implementations of this invention may use other color light sources, an ultraviolet light source, or ambient light. Under typical room lighting or outdoor sun, and with a conventional CMOS imager/camera, the image captured will have elements of both the capillary bed pattern and the surface ridge pattern overlaid upon each other. This has some inherent privacy advantage for the capillary bed pattern, as it is somewhat obscured and therefore more difficult for a hacker to secretly capture. To isolate and enhance the capillary bed pattern image, this invention may use specialized hardware and/or software.

To enhance the image of the capillary bed pattern, this invention may utilize linear polarizers, circular polarizers, color filters, and/or image processing software. The polarizers are typically filters constructed of glass or plastic film. For example, a linear polarizer filter placed over the light source and a second linear polarizer filter with its axis of polarization rotated 90° placed over (or within) the camera will block specular (mirror-like) reflection from the surface of the skin while passing scattered, diffuse reflection. This configuration will enhance the image of the capillary bed pattern (which is diffuse scattering reflection by nature), and reduce or eliminate the image of the palm ridge pattern (which has a significant proportion of specular reflection caused by surface skin oils. This will reduce the noise in the image. Alternatively, a circular polarizer, oriented with its linear polarizer side facing the light source and camera system and its quarter wave plate side facing the user's hand, will also block the specular reflection from the surface of the hand while passing the diffuse reflection from the mottling image.

One embodiment of the invention uses a single camera with a linear polarizer in its optical path and one or more LEDs with linear polarizers oriented perpendicular to the camera's polarizer, and one or more additional LEDs with linear polarizers oriented parallel to the camera's polarizer. This way, one image can be taken only illuminating the LED(s) with perpendicular polarizer(s), to capture the mottling image of the skin, and a second image can be taken only illuminating the LED(s) with parallel polarizer(s) to capture the ridge pattern of the skin. Those two images could be taken in succession. Alternatively, if a different color (red, green, or blue) is used for the parallel-polarizer LED(s) than for the perpendicular-polarizer LED(s), then both images can be captured simultaneously in a single image by a color CMOS image sensor with both types of LEDs illuminated. In this implementation, the color pixels matching the perpendicular-polarization LED(s)'s color (preferably green or blue) will form the capillary bed pattern image, and the pixels whose color matches the parallel-polarizer LED(s)'s color will form the ridge pattern image. It is straightforward for software to separate the different color channels and then process the different types of images separately. This delivers multi-biometric feature information at higher speed, lower cost, and/or smaller size.

In a preferred embodiment of the invention, a blue, green, or blue-green light source is used to illuminate the palm of the hand, and either a monochrome or a color CMOS image sensor is used to capture the palm image. A color CMOS image sensor typically has red, blue, and green wavelength pass color filters applied over individual pixels, so that a given pixel is primarily responsive to the corresponding color. It may be advantageous to remove the effects of ambient light from the raw image captured in this invention, and this may be accomplished by considering the image data in the red pixels of the color image. Since the intended illumination for capturing the capillary bed pattern is blue and/or green in color, data in the red pixels corresponds to ambient light effects, which may be considered noise obscuring the true capillary bed pattern. Such ambient light may be room light scattering onto or through the hand, or may be overhead lighting or sunlight outside the perimeter of the fingers or hand. It is noted that the palm ridge pattern is also more effectively imaged using light in the blue-green region of the spectrum, and these ambient light reduction techniques apply to capturing palm-ridge or fingerprint images as well. Alternatively, the ambient light effects may be determined by capturing two successive images with the camera system, one image with the blue-green light source illuminated and one image with that light source off. Image data in the “off” image will be created by ambient light effects. That technique can be used with either a color or a monochrome CMOS image sensor. A person skilled in the art will recognize that a software subtraction function or masking function based on the red pixel data, or the “off” image data, can be used to reduce or eliminate the effects of ambient light in the raw image data.

Generally, the optical system that captures the capillary bed pattern will also capture the image of the palm creases. Different implementations of the invention may consider this to be advantageous or disadvantageous. In the former case, the biometric template may derive features from both the capillary bed pattern and the palm creases, and then perform a match based on matching both types of features. This may even be helpful as the palm creases can provide hand orientation/position information and provide the ability to preclassify the template in large database identification systems. Conversely, if the application requires the crease pattern to be handled separately from the mottling image, or eliminated from the mottling image, then software filtering may be necessary. An additional method for isolating the palm crease pattern would be to illuminate the hand with substantially red light and capture a palm crease image. Red light will reduce the signal from the capillary bed pattern and palm ridges, while still showing the palm crease pattern. With the palm crease pattern isolated, it can be subtracted from the other features' images, or it can be used to define “ignore” areas where mottling or palm ridge features should be handled differently or omitted.

The raw image of the capillary bed pattern captured by the camera system is likely to be low in contrast and can have variations in local average intensity. The variation in local average intensity may be caused by optical characteristics of light sources (including non-uniformity of intensity and variation in illumination angle), shadows on the hand or body part because of its non-flat shape, angle of presentation of the hand or body part, optical characteristics of the camera system, and/or actual variations in reflectivity of the skin and flesh of the body part. Since it is advantageous to normalize and enhance the contrast of the capillary bed pattern image, software image processing may be used. The form of this image processing may take the form of global contrast enhancement, local contrast enhancement (also known as clarity or micro-contrast), sharpening filters, histogrammic equalization, and/or other image processing techniques. In addition, spatial filtering (lowpass, highpass, and/or band pass) may be applied to the image as the useful capillary bed pattern information occurs in a certain range of spatial frequencies. Signals outside this range can be considered noise and would preferably be discarded. All these types of software filters, which may be used jointly, can enhance and equalize the pattern of interest across the whole field of view while minimizing noise, offset, edge effects, and other undesirable artifacts in the image.

When the hand is presented at different times, there are likely to be differences in position, distance, rotation, separation of the fingers, and degree to which the hand is “splayed” or “cupped.” These transformations will influence the relative positions of the identifiable biometric features in the mottling image or other image(s). Therefore, it is advantageous to make measurement of these hand presentation characteristics and then compensate for the resultant change in position of the biometric features. Methods to measure the hand presentation include, but are not limited to, measuring the outline of the hand (which may include finger(s)), and measuring the positions of the creases in the palm of the hand. When the transform function of those macro hand features is computed, then either the image can be transformed to a canonical shape/position/rotation/size for consistent feature extraction, or the features in the template can have their positions transformed to better match the corresponding condition for the registration template. The use of distance-measuring sensors or auto-focus techniques may also be used.

Digital algorithms can convert the capillary bed pattern image into a representation of that image, called a template. The template is generally smaller in digital size (measure in bytes) than the raw image, is formatted in such a way to facilitate matching it against another template, and may be encrypted for security reasons. The stored template of the capillary bed pattern may take the form of an image, a compressed image, a multitude of sub-images, or a mapping of features within the pattern. Such features in the capillary bed pattern image can be local minima in the image brightness, local maxima in the image brightness, contour plots of the image, and/or distinct shapes in the pattern.

As a person skilled in the art of biometric authentication knows, one template is generated during the initial process of user “registration,” (also known as “enrollment”) and that template (the “registration template” or “stored reference data”) is stored in a computer system. Often multiple image captures occur during registration to determine and store the highest-quality template by selecting the “best” image, by merging multiple images, and/or by more heavily weighing features that are persistent through the multiple image captures. The computer system performing the registration and storing the registration template can be a mobile device, an electronic token, an embedded computer, a personal computer, a mainframe computer, a server in a company, or a server “in the cloud” of internet-connected web-servers, or some combination of these. At some later time, a user will present their hand or body part to the electronic reader of this invention, and a new template is generated, often called the “authentication template” or the “identification template,” or “matching template.” That template is compared against the registration template(s) stored in the computer system to determine if there is a match. If a match is confirmed, the user is granted access. Such access may be to a computer, a web service, or it may be physical access to a doorway, gate, or the like. At the conclusion of the biometric matching process, the authentication or identification template is usually deleted; however, a record of the transaction may be saved.

The matching process will typically include software algorithms that compensate for the authentication template rarely or never being bit-for-bit identical to the registration template. Because of the inherent noise in optical/electronic systems, the variation in human body and external conditions, and the imprecise nature of biometric data, the templates will be different even when they are representations of the same human biometric trait. Therefore, matching algorithms are complex and designed to compensate for variations including, but not limited to, noise in the electronic system, noise in the optical system, different presentation of the body part (rotation, distance, angle, distortion, warped skin, differing areas presented, dirt on the body part, and the like), human body changes (growth, injury, aging, use of lotions or the like), changes in ambient conditions and their effect on the human and electronic systems (temperature, ambient light, humidity, vibration, and the like). Biometric templates and matching algorithms designed to perform a biometric match based on the mottling image will need to consider and compensate for these variations. Most biometric systems allow for some tolerance in relative locations of biometric features. Most biometric systems do not require 100% of the features to match; rather a determination is made as to whether a statistically significant subset do match. Some biometric matching algorithms utilize mathematical functions such as “affine transform” to compensate for warping and stretching of skin. The matching algorithm may perform mathematical correlation functions on subsets of the hand (or other body part) image data. A high confidence match will only be declared when a significant number of the subsets overlap with reasonably high correlation scores, and acceptably similar rotation angle, relative position, etc.

Mathematical correlation functions, as described here, may take the form of performing statistical overlap scores as one 2D matrix of values is translated, rotated, and magnified relative to the reference matrix, also called “convolution.” The maximum correlation score achieved because of the variations can give insight as to the similarity of the two matrices as well as the position/rotation/magnification that yields the maximal overlap, even in the presence of noise and imprecise data. Biometric matching algorithms that use templates based on the capillary bed pattern can be developed using Machine Learning or Artificial Intelligence or Neural Network methodologies. In such methodologies, specialized tools process large databases of both matching and non-matching biometric images or templates and derive matching algorithms without the need for manual coding.

While the use of certain hand and palm features for biometric authentication and identification including palm ridges, palm creases, hand geometry, and hand veins is known to those skilled in the art, the combined use of the capillary bed pattern of this invention with one or more of those public domain (legacy) biometric methodologies is envisioned and has certain advantages. This invention can also image, record, and match both the capillary bed pattern as well as creases in the skin. This invention can also image, record, and match both the capillary bed pattern as well as the surface ridge pattern of the skin. The skin in this instance could be the skin of the fingertip(s) (the surface ridge pattern in this case being the conventional fingerprint(s)), and/or the skin of the palm-side fingers, and/or the skin of the palm of the hand. This invention can also image, record, and match both the capillary bed pattern as well as large blood vessels in the hand. This invention can also image, record, and match both the capillary bed pattern as well as the geometry of the hand. This invention can also image, record, and match characteristics formed by melanin in the skin, including freckles or other dark features of people with darker skin.

Such multi-modal biometric readers (where both the capillary bed pattern and at least one other palm characteristic are captured and matched) would have advantages including higher biometric accuracy, improved pre-classification ability for identification against very large databases, improved resistance to spoof attacks, ability to work across a wider demographic range of users, ability to work in a wider variety of external conditions, use of common hardware components, and cross-correlation between different types of image. That cross-correlation may enable position (anchor points) and/or orientation information for improved geometric correlation between images.

One example of a multi-modal variation of this invention is an apparatus that can image, record, and match both the capillary bed pattern of the fingertip(s) as well as the fingerprint(s) of those same finger(s). Such a device may work in a non-contact mode. Alternatively, such a device may work in a “touch” or contact mode; in such a case, it may be desirable to capture the capillary bed pattern of the fingertip at a point in time just prior to the finger making contact with the reader, because of the “blanching” effect of contact described previously. In such an embodiment, if the fingerprint capture camera works in the “frustrated total internal reflection” (FTIR) mode, then a second camera would be necessary to capture the capillary bed pattern because an FTIR camera/optical system is unable to capture an image of the finger that is not in direct contact with the platen (prism) surface.

One example of a multi-modal variation of this invention is an apparatus that can image, record, and match both the capillary bed pattern as well as the surface friction ridge pattern on parts of the palm of the hand. The surface friction ridge pattern is very similar to a fingerprint pattern: it takes the form of a series of locally parallel or concentric ridges at a typical spacing of 0.25 to 1 mm that have whorl, arch, and delta patterns and whose ridges bifurcate or end at “minutiae points.” There are several advantages to imaging, recording, and matching both the capillary bed pattern and palm ridge pattern of a user's palm in a single device. The advantages include higher accuracy, usability over a larger population, usability over a wider range of environmental and/or lighting conditions, usability over a wider range of positional alignment of the hand relative to the reader, and higher resistance to spoof attacks. Geometric correlation between features in the capillary bed pattern and features in the ridge pattern provide advantages to accuracy, advantages to alignment between registration hand image data and input verification hand image data, may speed up processing, and/or may allow for a smaller area of the hand to be presented while still achieving high matching accuracy. By reading and matching both a complex capillary bed pattern and a complex palm ridge pattern, the number of matchable features is increased, improving accuracy. By reading and matching both a complex capillary bed pattern and a complex palm ridge pattern, the difficulty in constructing a spoof hand to fool the system is greatly increased.

The surface palm ridge data may take the form of a mapping of minutiae points, which is well known to those skilled in the art of fingerprint recognition. However, in a non-contact implementation of this invention, it may be difficult to reliably read enough minutiae points, and therefore a ridge orientation mapping may be preferable. The ridge orientation mapping of localized ridge directions is more easily determined in the presence of noise, low signal, or suboptimal hand position, since only fragments of ridges are necessary to determine their direction. Core points and delta points (as distinct from minutiae points) can be determined from the ridge orientation map. While palm ridge flow data may not yield very high accuracy biometric matching taken alone, when it is layered with the capillary bed pattern data the resultant system will have even higher accuracy and resistance to spoof attacks.

Another implementation of the invention captures three aspects of the hand during each biometric capture event: the capillary bed pattern, the ridge pattern, and the large vein pattern of the hand. Those patterns can be captured from the palm area and/or the fingers. As noted previously, capturing more biometric information has advantages of higher accuracy, usage over a wider population, and improved resistance to spoof attacks.

The invention may be implemented as a dedicated hardware device, as a hardware module embedded into a larger hardware system, or as software in a computer or mobile device. In the latter case, the invention may utilize the cameras and/or light sources already integral to the device. Dedicated hardware embodiments of the invention include but are not limited to: a desktop peripheral reader or a door entry device. As an embedded hardware device, the invention could take the form of a small module mounted inside a larger device including but not limited to a computer, a mobile device (including a mobile phone or tablet), a mouse, a safe, a weapon, a timeclock, a door entry device (including a door lock), an automobile, a turnstile, a kiosk, a voting machine, a point of sale terminal, a transportation gate, or the like. Because this invention works over a short distance to the hand, one application of this invention would comprise a reader placed on the inside glass of a door or its adjacent window. The user on the outside would present their hand near the glass opposite the reader, and upon a match, the door would unlock. This has advantages in ease-of-installation, prevention of tampering, avoidance of outdoor weather conditions, etc.

A preferred embodiment of the reader of this invention would have several ergonomic or industrial design characteristics. An icon of a hand, possibly illuminated, would give visual indication to the user which hand to use (left or right) and guidance as to the approximate position of the hand relative to the reader for optimum functionality. A substantially flat or domed-top reader might lead users to erroneously place their hand in contact with the reader. Therefore, some protuberances from the reader surface will give clues that the user's hand should not touch the reader.

In a preferred embodiment of the invention, it is anticipated that the hand will be brought to a distance of 40 mm to 150 mm from the reader device, although implementations that work closer or farther can also be constructed. The reader can have a preferred working distance, and/or a range of distances that can be accepted. A person skilled in the art will recognize that distance-measuring sensors, auto-focus camera systems, and/or software magnification techniques can be used to measure, image, and compensate for hands presented at different distances from the reader. In a preferred embodiment of the invention, some form of feedback is given to the user to aid in correct usage of the device. The purpose of the feedback can be to indicate the hand being too far from the reader, the hand being too close to the reader, the hand being off-center from the reader, the hand being in a good position, the hand not holding sufficiently still, reading in process, reading complete, and “hand may now be removed.” The form of the feedback can be audible sounds, icons, animations, or words on a screen, and/or LEDs that change color, intensity, or pattern. For registering (or authenticating) on a mobile device where there are not polarizers to suppress the surface reflection from ridges, the reader can save data only for the valley areas. The reader could require the subject to move the hand being imaged to force ridge reflections to move, enabling the ridge reflections to be subtracted from the image data. Mobile device hand scans using selfie cameras have the advantages of providing the subject with a live image to help with centering the palm. The screen of the mobile device could also be programmed to flash different colors during the imaging process to prevent a playback attack using the screen and to collect additional biometric data made visible by each of the different colors.

The capillary bed patterns in the palm of the hand and palm side of the fingers have been observed to be largely constant, though not absolutely identical, over a period of time greater than one year. Most “splotch” locations and their general shapes remain largely fixed; however, a small minority of the “splotches” fade, alter their shape, or disappear, and a small number of new “splotches” appear, over time. These changes may be caused by human body changes. Other differences in the capillary bed pattern between the initial reference capture image and a later verification image may be because of stray reflections, dirt, change in palm presentation (angle, distance, or being off-center), different ambient conditions (external light, temperature, or humidity), and/or other noise signals present during the image capture. For these reasons, it may be advantageous to use “learning” or “adaptive” algorithms when matching a user to their stored template. A “learning” or “adaptive” algorithm will slightly update the stored reference template to account for changes in the biometric feature, for different conditions, for different or improved hardware, or the like. It should be noted that a “learning” or “adaptive” algorithm will only update the stored reference template if a strong majority of the stored features match the presented sample, so as not to result in the false match of an imposter. Furthermore, the “learning” or “adaptive” algorithm might only add, subtract, or modify the stored reference template after multiple presentations of the hand or body part give statistical confidence that the change in the capillary bed pattern is persistent and not spurious. Alternatively, natural changes in the capillary bed pattern can be used by the invention to create a self-expiring biometric. In this example, changes to the capillary bed pattern occurring over several years is used as an advantage. For instance, the reader can force the user to reregister every year, with a new private key, DID (decentralized identifier), and biometric read. Blockchain technology could be used to manage the biometric data's expiration date.

The use of the capillary bed pattern for biometric matching has certain privacy advantages for the user over conventional biometric modalities such as fingerprint or face. Some users prefer not to use fingerprint recognition biometric systems because fingerprints have the disadvantages of being “liftable” from touched objects, having extensive databases of fingerprints accessible to many people tied to user identities held by law enforcement and other organizations, and being associated with criminality. Some users prefer not to use facial recognition biometric systems since faces have the disadvantages of being publicly viewable, being widely obtainable from internet social media and other sources, being subject to widespread capture by surveillance systems, and being capable of being used by governments or other organizations to track people against their will. In contrast, the capillary bed pattern of the skin is not “liftable” from touched objects, and it is highly unlikely to be captured by distant surveillance systems against an individual's will. Thus, the user of a capillary bed pattern biometric system: retains more control over the privacy of their biometric data, more control over when and if to present their hand or other body part to a reader, and/or more control over whether their biometric data may be cross-matched to other databases without their knowledge or consent.

To further enhance the privacy of the individual, a biometric system utilizing the capillary bed pattern may store templates in a “digital wallet,” often contained in the individual's mobile device. This distributed usage mode has the advantage that credentials are not stored on a central server, which could be compromised. Furthermore, the user maintains control of how and where his or her credential may be used, and the user maintains the “right to be forgotten” through their ability to delete their credentials if they so choose. Furthermore, the biometric match based on the capillary bed pattern of this invention lends itself to “anonymous” authentication, in which a user is able to securely prove their membership, or age, or nationality, or voter status, or vaccination status without ever needing to reveal their name or address or other personally-identifiable information.

To further enhance the privacy and user control of biometric credentials, the invention may use homomorphic encryption to secure the capillary bed pattern biometric template. Homomorphic encryption has the advantage that mathematical matching functions can be performed against templates that remain in their encrypted state. The advantage is the registration template is never decrypted, and the registration template can be revoked or deleted by the user if they fear it has been compromised. In such a case, the user can re-register their biometric with new encryption keys, rendering the previous compromised credential useless. The use of homomorphic encryption is particularly suited to biometric templates based on the capillary bed pattern because of these privacy advantages.

It is envisioned that one application of this invention would be in systems utilizing Decentralized Identifier technology to store credentials in a digital wallet. It is envisioned that one application of this invention would be in systems utilizing blockchain technology to store transactions, rights, and possibly anonymized credentials in a way that is tamper-proof and readily accessible.

In one implementation of the invention, the optical components of the reader (including, but not limited to, the camera device) are additionally used to read a barcode or QR code which can be displayed on the screen of a mobile computing device such as a mobile phone or tablet. This ability has application where it is advantageous for the biometric system to make a one-to-one or one-to-few authentication rather than a one-to-many identification. Such advantages include speed, privacy, and accuracy. The one-to-one or one-to-many match may take place on the user's mobile device. The QR code may include security features such as a key to secure wireless communication between the reader and the user's mobile device such that any man-in-the-middle interception of the digital communication would not yield private biometric data, and could not be spoofed with fraudulent communication. The QR code or the like may be different for every transaction and have an expiry period for additional security. There are many more digital communication architectures that could use the biometric reader of this invention: the use of the reader to scan codes or information from the user's mobile device, a digital wallet (or other secure storage on a mobile device or token), an app on the mobile device, and/or digital records (credentials, privileges, keys, biometric data, personal data, identification numbers, and the like) stored on the internet.

In one implementation of the invention, the reader could read a passport, driver's license, ID card, membership card, credit/debit card, other paper-based credential, or other information displayed on the screen of a mobile device such as a mobile phone. This would have advantages including, but not limited to, a dual-purpose reader that can authenticate a person through biometrics, legacy credentials, or both biometrics and legacy credentials, and a single reader that can more easily biometrically enroll a new user through use of their legacy credentials as well.

In another implementation of the invention, the reader is tied to a wireless communication circuit designed to communicate with the user's mobile device. Similar to the description of an architecture using a QR code above, the wireless communication can facilitate a one-to-one or one-to-few authentication without the registration biometric credential leaving the user's mobile device. The use of encryption, preferably using asymmetric cryptography, would enable secure communication without biometric information being transmitted unencrypted and also preventing the replay of previous communication to spoof the system.

Indication of access approved or denied would also travel in a secure, encrypted way, with a short expiry period. If the reader is the device to indicate or electronically grant access, the reader will need to tie the final received match determination with either the key(s) used for this transaction and/or the biometric data (or a hashed representation of the data) collected during the transaction.

It should be noted this invention can capture an image of the capillary bed pattern (and other characteristics of the hand) using monochromatic light. Although there is discussion of different wavelengths that might be chosen, the mechanism for creating the image of the capillary bed pattern is not multispectral imaging. Although there is discussion of using different wavelengths of light to image different features and/or to enable different color pixels in a color image sensor to respond to images taken with differing illumination sources, this too does not mean the mechanism for imaging any feature depends on multispectral imaging. There is discussion of measuring the color of features of the image, and one skilled in the art will recognize that color may be measured different ways. For example, to measure the degree to which a spot of skin is has a higher or lower amount of ‘green’ in it, one could measure the ratio of the reflectance signal in the typically red, green, and blue pixels of the image under broadband (white) or monochromatic (in this case green) illumination. Likewise, the ‘greenness’ of a spot of skin could be determined by simply measuring the amplitude of the reflectance signal under green light illumination with either a color or monochromatic imager. Although this invention can capture and match the capillary bed pattern even if the hand is illuminated by sunlight, room ambient light, or the flash LED of a mobile device (which all tend to be white light), the underlying mechanism does not rely on the multispectral nature of the light.

While current embodiments of a system and method of biometric identification of a subject has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of biometric identification of a subject comprising:
providing a light source and an imager;
positioning a subject hand palm facing the light source and imager;
illuminating the palm with the light source;
capturing an image of the palm; and
determining characteristics of capillary beds in the image.

2. The method of claim 1 including the step of identifying the subject based on the characteristics of the capillary beds.

3. The method of claim 1 wherein determining characteristics of capillary beds in the image includes determining locations of the capillary beds.

4. The method of claim 1 including processing the image to filter image features of the palm other than the capillary beds.

5. The method of claim 4 wherein processing the image to filter image features of the palm other than the capillary beds includes removing surface ridge pattern features.

6. The method of claim 4 wherein processing the image to filter image features of the palm other than the capillary beds includes spatially filtering to remove detail with a frequency of less than a selected threshold, the selected threshold being less than 1 mm.

7. The method of claim 1 wherein illuminating the palm includes illuminating with visible light.

8. The method of claim 1 wherein illuminating the palm includes illuminating with primarily green light.

9. The method of claim 1 wherein illuminating the palm includes illumination with light having an energy spectrum mostly below a wavelength of 575 nm.

10. The method of claim 1 wherein illuminating the palm includes illumination with light having a percentage energy content in the red and infrared wavelengths of less than 5%.

11. The method of claim 1 wherein illuminating the palm includes illumination with polarized light.

12. The method of claim 1 including providing a circular polarizer between the palm and both the light source and the imager.

13. The method of claim 1 wherein capturing an image includes capturing additional biometric feature information about the hand, the additional information biometric feature including at least one of hand periphery, surface ridges, fingerprints, minutiae, creases, and blood vessels.

14. The method of claim 13 where a biometric match is determined based on location information of the capillary beds and location information of the additional biometric features.

15. The method of claim 1 including positioning the palm away from the light source and the imager.

16. A system and method of biometric identification of a subject comprising:
providing a light source and an imager;
positioning a subject hand palm facing the light source and imager;
illuminating the palm with the light source;
capturing an image of the palm;
determining an apparent color of each of a multitude of locations across the palm; and
based on the determination of the color, determining the location of subcutaneous features.

17. The method of claim 16 wherein determining the location of subcutaneous features includes limiting determination to features having a typical spacing of 1-10 mm.

18. The method of claim 16 wherein determining the location of subcutaneous features includes limiting determination to features having mottled characteristics having insular minima or maxima.

19. The method of claim 16 wherein determining the location of subcutaneous features includes limiting determination to avoid determination of features having elongated characteristics.

20. The method of claim 19 wherein features having elongated characteristics includes visibly distinct veins and surface ridges.

21. The method of claim 16 including the step, based on the location of subcutaneous features, identifying the subject.

22. The method of claim 16 including processing the image to filter image features of the palm other than the subcutaneous features.

23. The method of claim 22 wherein processing includes removing surface ridge pattern features.

24. The method of claim 16 wherein illuminating the palm includes illuminating with visible light.

25. The method of claim 16 wherein illuminating the palm includes illuminating with primarily green light.

26. The method of claim 16 wherein illuminating the palm includes illumination with light having an energy spectrum mostly below a wavelength of 575 nm.

27. The method of claim 16 wherein illuminating the palm includes illumination with light having a percentage energy content in the red and infrared wavelengths of less than 5%.

28. The method of claim 16 wherein illuminating the palm includes illumination with polarized light.

29. The method of claim 16 including providing a circular polarizer between the palm and both the light source and the imager.

30. The method of claim 16 wherein capturing an image includes capturing additional biometric feature information about the hand, the additional biometric feature information including at least one of hand periphery, surface ridges, fingerprints, minutiae, creases, and blood vessels.

31. The method of claim 30 where a biometric match is determined based on location information of the subcutaneous features and location information of the additional biometric feature information.

32. The method of claim 16 including positioning the palm away from the light source and the imager.

33. A biometric identification system comprising:
a light source operable to illuminate a skin surface of a live subject spaced apart from the light source;
an imager operable to generate an image of the skin surface; and
a processor operable to process the image to determine locations of capillary beds below the skin surface.

34. The biometric identification system of claim 33 including a polarizer between the light source and the subject.

35. The biometric identification system of claim 34 wherein the polarizer is a circular polarizer between both the light source and the imager, and the subject.

36. The biometric identification system of claim 33 including a first linear polarizer having a first orientation between the light source and the subject, and a second linear polarizer having a different second orientation between the imager and the subject.

37. The biometric identification system of claim 33 wherein illuminating the skin surface includes illuminating with visible light.

38. The biometric identification system of claim 33 wherein illuminating the skin surface includes illuminating with primarily green light.

39. The biometric identification system of claim 33 wherein illuminating the skin surface includes illumination with light having an energy spectrum mostly below a wavelength of 575 nm.

40. The biometric identification system of claim 33 wherein illuminating the skin surface includes illumination with light having a percentage energy content in the red and infrared wavelengths of less than 5%.

41. The method of claim 33 wherein generating an image includes capturing additional biometric feature information about the hand, the additional biometric feature information including at least one of hand periphery, surface ridges, fingerprints, minutiae, creases, and blood vessels.

42. The method of claim 41 where a biometric match is determined based on location information of the capillary beds and location information of the additional biometric feature information.
